(19) United States
(12) Patent Application Publication
(10) Pub. No.: US 2007/0113746 A1
(43) Pub. Date: May 24, 2007

(54) Rotary engraving apparatus

(76) Inventors: John D. Lundberg, Denham Springs, LA (US); Guy S. Barone, Baton Rouge, LA (US)

Correspondence Address: Ted M. Anthony, Post Office Drawer 3408, Lafayette, LA, 70502, US

(21) Appl. No.: 11/655,033

(22) Filed: Jan. 18, 2007

Related U.S. Application Data
(63) Continuation of application No. 10/782,428, filed on Feb. 18, 2004, now abandoned.

(51) Int. Cl. B44B 5/00

(52) U.S. Cl. 101/3.1

(57) ABSTRACT

An apparatus for controlling engraving devices, such as computerized rotary engraving machines, having a central processor for receiving stored data regarding engraving job parameters. A portable device having a touch pad permits additional data input during engraving operations.

### CROSS REFERENCES TO RELATED APPLICATIONS

THIS APPLICATION CLAIMS THE BENEFIT OF U.S. NON-PROVISIONAL PATENT APPLICATION Ser. No. 10/782,428, FILED Feb. 18, 2004, CURRENTLY PENDING.

### STATEMENTS AS TO RIGHTS TO INVENTIONS MADE UNDER FEDERALLY SPONSORED RESEARCH AND DEVELOPMENT

NONE

### FIELD OF THE INVENTION

The present invention relates to an apparatus used in connection with automated rotary engraving devices. More particularly, the present invention relates to a control mechanism for automated rotary engraving devices.

### BACKGROUND OF THE INVENTION

The invention relates to a control device for engraving machines and, more particularly, computerized rotary engraving devices. Currently, standard engraving machines have a number of limitations. Such limitations include, but are not necessarily limited to, engraving speeds of less than six (6) inches per second, minimal control over engraving job parameters, and serial communication connections. Furthermore, standard computerized engraving machines typically provide limited job performance data to user(s) and require multiple operational steps in order to perform basic engraving functions. Each of these limitations can reduce throughput productivity of an engraving device, which in turn results in increased operating costs.

### SUMMARY OF THE INVENTION

It is an object of the invention to facilitate high speed engraving and to increase engraving productivity. Such objections are obtained by enabling faster job download speeds, allowing convenient access to productivity enhancing job control features, and providing job performance data to user(s).

In the preferred embodiment, the components of the present invention comprise two major elements: (1) a portable, hand-held pendent having a touch screen key pad; and (2) a controller/motor power unit. Said controller/motor power unit houses an electronic board stack that receives engraving job input data and sends control signals to stepper motors of an engraving table.

Engraving job data is transmitted, typically via cable connections, from a processor or comparable application program running on a computer or network to the electronic board stack of said controller/motor power unit. Such data is received by said electronic board stack and processed in said board stack. Further, additional engraving job parameters can also be provided by an operator using said hand-held pendent. Resulting signals are then sent from the electronic board stack of said controller/motor power unit to stepper motors located on an engraving table, typically via a table cable, in order to carry out an engraving job.

The touch screen of said hand-held pendent provides for convenient management of an engraving job. Said touch screen permits selection of engraving parameters on a host computer's hard drive during all phases of an engraving job, including the implementation of said job on an engraving table. In addition, said touch screen allows a user to preview a job, and adjust a number of different engraving functions and parameters. For example, said touch screen can be used to control home positions, job home setup, job positioning, speed adjustments, mechanical home, replay, pause and stop commands, as well as engraving by plate, line and character. Said touch screen also provides real time job performance data to a user, such as X, Y and Z coordinate positions, as well as file name, job time, and engraving speed parameters.

The controller board design allows for interpolation of 4 axes simultaneously, as well as the ability to configure and set current for any drive as an X, Y, Z, or cylindrical attachment drive. Furthermore, said controller board also permits use of Ethernet communications through proprietary software, and on-board diagnostics showing motor condition, drive temperature, and bus voltage.

### BRIEF DESCRIPTION OF THE DRAWINGS

FIG. 1 is a perspective view of the components of the present invention.

FIG. 2 is an overhead partial cut-away view of the controller/motor power unit of the present invention.

FIG. 3 is a side perspective and partial cut-away view of the controller/motor power unit of the present invention.

FIG. 4 is an overhead view of the hand-held pendent of the present invention.

FIG. 5 is a side view of the hand-held pendent of the present invention.

### DETAILED DESCRIPTION OF A PREFERRED EMBODIMENT

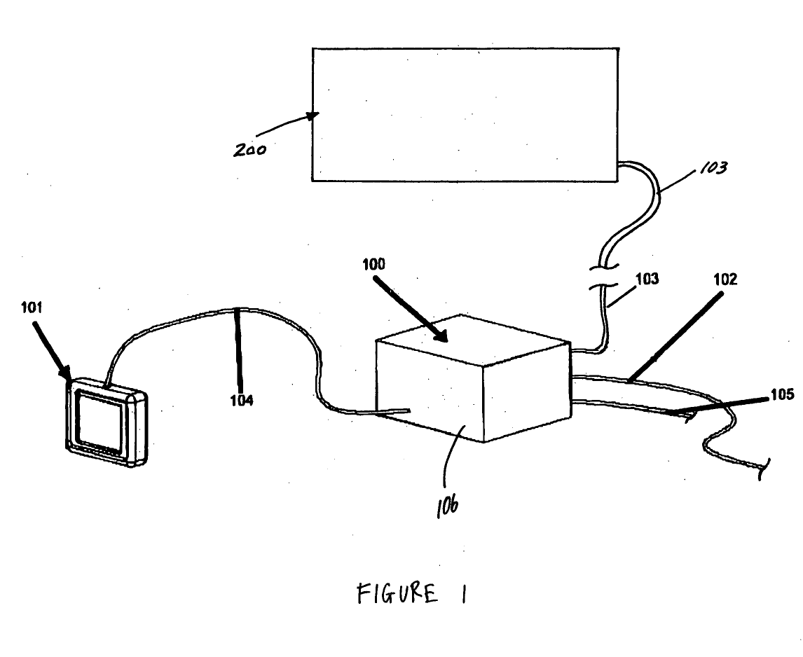

FIG. 1 depicts a perspective view of the present invention. In the preferred embodiment, the present invention comprises controller/motor power unit 100 and hand-held pendent 101. Controller/motor power unit 100 is contained within housing 106, which is typically a metal box or similar protective enclosure. Cables 102, 103, 104 and 105 allow communication between controller/motor power unit 100 and hand-held pendent 101 of the present invention, a host computer or related network, and a rotary engraving device that will actually perform an engraving function. Cable 102, typically a standard high speed Ethernet cable, connects controller/motor power unit 100 to a computer, while cable 103 connects said controller/motor power unit 100 to an engraving device such as rotary engraver 200. Rotary engraver 200 can be one of any number of such devices known in the art. Cable 104, typically a 25 pin data cable, in turn links hand-held pendent 101 with said controller/motor power unit 100. Power cable 105 provides power to controller/motor power unit 100 from an external power supply, such as a standard wall outlet or the like.

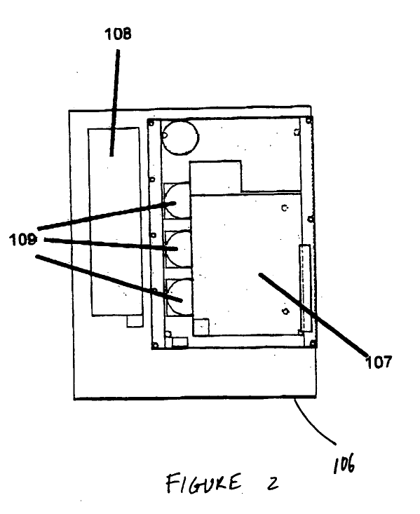

FIG. 2 depicts an overhead partial cut-away view of controller/motor power unit 100 of the present invention. In the preferred embodiment, controller/motor power unit 100 consists of enclosure 106 that houses electronics board stack 107. Power is supplied from an external source to power component 108 (via power cable 105, not shown in FIG. 2), which in turn provides power to electronics board stack 107 and hand-held pendent 101, as well as a plurality of thermally controlled cooling fans 109. Although many different configurations can exist, in the preferred embodiment electronics board stack 107 typically comprises a 4-axis driver board, software programmable drive current and over voltage protection. Electronics stack 107 also contains on-board diagnostics which can provide data regarding motor condition, drive temperature, and bus voltage to a user.

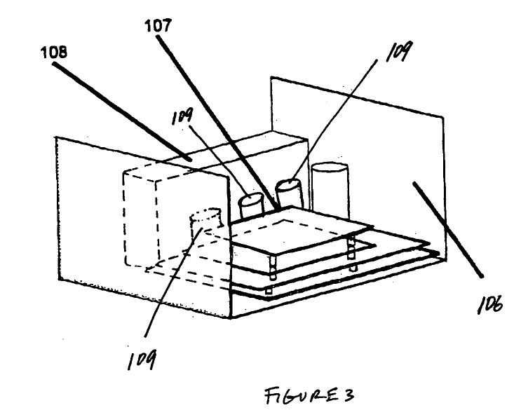

FIG. 3 depicts a side perspective and partial cut-away view of the controller/motor power unit of the present invention. In the preferred embodiment, controller/motor power unit 100 consists of enclosure 106 that houses electronics board stack 107. Power is supplied from an external source to power component 108, which in turn provides power to electronics board stack 107 and hand-held pendent 101, and thermally controlled cooling fans 109.

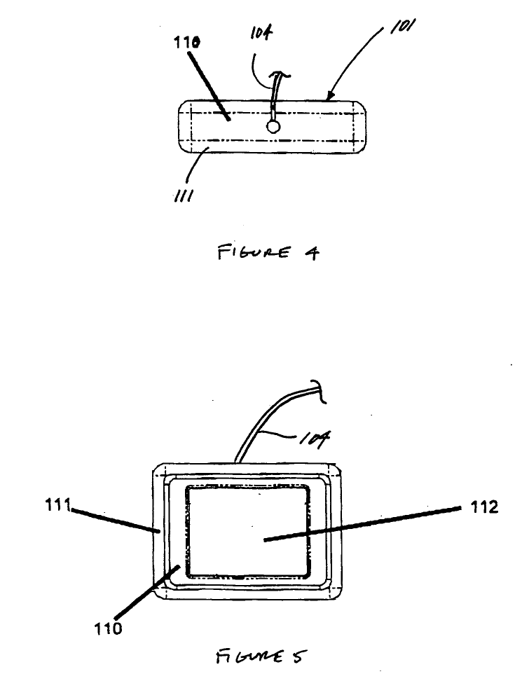

FIG. 4 depicts an overhead view of hand-held pendent 101 of the present invention. Hand-held pendent 101 comprises a touch screen (not shown in FIG. 4) which is encased within rigid case 110 (shown in outline in FIG. 4). Rigid case 110 is in turn encased within exterior frame 111. Cable 104 links hand-held pendent 101 with controller/motor power unit 100 and, ultimately, the other components of the present invention.

FIG. 5 depicts a side view of hand-held pendant 101 of the present invention. In the preferred embodiment, hand-held pendent 101 comprises rigid case 110 covered by exterior frame 111. Touch screen 112 is mounted near the center of said hand-held pendent 101 within rigid case 110. Said touch screen serves as a control interface between a user and system engraving electronics. Said touch screen 112 allows a user to set engraving parameters such as x, y and z coordinates, home positions and job offsets. Said touch screen 112 also permits toggling between metric and imperial units, enabling HPGL use, accessing of test engraving jobs, selecting display languages, replaying (re-engrave) a job, pausing a job during or before engraving at the character, line, or plate level, changing engraving speed, changing engraving depth, stopping the machine at character, line, or plate level, forwarding to a particular character, line, or plate, and performing maintenance functions. In addition, users may access engraving jobs located on a host computer's hard drive from said touch screen 112, select a job for use, and/or proceed with engraving operations. Said touch screen 112 also displays job information including, without limitation, job name, job date, file size, X, Y, and Z positions, job preview data, pan view, and zoom view.

In operation, a user will typically create an engraving job data file (typically in the form of software file instructions) on a computer. Although different software can be used for this purpose, Applicant's proprietary XGW-32 software package is ideal for this purpose. Similarly, other engraving software, including software which can be loaded on a personal computer, can also be used for this purpose.

For jobs that have been stored on a computer hard drive or network drive, a user can select a series of menu input parameters displayed on touch screen 112 of hand-held pendent 101 to browse and, if desired, select a desired engraving job from stored memory. The engraving data file can be sent directly to the components described herein, via cable 102, or stored on a computer hard drive or in a network drive. If a data file is sent directly, such file is received by electronics board stack 107 housed in controller/motor power unit 100 and stored in random access memory on said electronics board stack 107. The system, if not previously instructed, awaits additional user input via hand-held pendent 101. A user can select one or more menu choices on touch screen 112 pad of said hand-held pendent 101 in order to provide instructions to electronics amplifiers contained in electronics board stack 107 contained within controller/motor power unit 100. Pulses are then sent from said electronics amplifiers to the stepper motors of an engraving table via cable 103. Said stepper motors in turn drive the engraving performed on an engraving device.

Whereas the invention is herein described with respect to a preferred embodiment, it should be realized that various changes may be made without departing from essential contributions to the art made by the teachings hereof.

What is claimed:

1. A control apparatus for a rotary engraving device comprising:
a. a controller unit comprising:
(i) at least one processor;
(ii) a first data input port;
(iii) a second data input port; and
(iv) at least one data output port;
b. a hand-held data input device connected to said first data input port of said controller unit;
c. a computer processor connected to said second data input port of said controller unit; and
d. means for transmitting data from said controller unit to a rotary engraving device through the data output port of said controller unit.

2. The control apparatus of claim 1, wherein said hand-held data input device comprises a touch screen.

3. A control apparatus for a rotary engraving device comprising:
a. a controller unit comprising:
(i) at least one processor;
(ii) a first data input port;
(iii) a second data input port; and
(iv) at least one data output port;
b. a hand-held touch screen connected to said first data input port of said controller unit for inputting engraving job data to said controller unit;
c. a computer processor connected to said second data input port of said controller unit for inputting engraving job data to said controller unit; and
d. means for transmitting data from said controller unit to a rotary engraving device through the data output port of said controller unit.

4. The control apparatus of claim 3, wherein engraving job data input from said hand-held touch screen is selected from the group consisting of: selecting x, y and z coordinates; selecting home positions and job offsets; toggling between metric and imperial units; enabling HPGL. use; selecting display languages; replaying jobs; pausing jobs at the character, line or plate level; changing engraving speed; changing engraving depth; stopping the machine at character, line or plate level; forwarding to a particular character, line or plate; performing maintenance functions; or accessing engraving job data located on a host computer.
